(19) United States
(12) Patent Application Publication
(10) Pub. No.: US 2006/0066821 A1
(43) Pub. Date: Mar. 30, 2006

(54) Contrast enhancement apparatus for projector

(75) Inventors: Wu Shih-Min, Padeh City (TW); Liu Chia-Lin, Padeh City (TW); I-Hwei Yen, Padeh City (TW); Lin Chia-Jin, Padeh City (TW); Ho Min-Tsung, Padeh City (TW)

Correspondence Address: BACON & THOMAS, PLLC, 625 SLATERS LANE, FOURTH FLOOR, ALEXANDRIA, VA, 22314, US

(73) Assignee: Chunghwa Picture Tubes., Ltd., Padeh City (TW)

(21) Appl. No.: 10/950,391

(22) Filed: Sep. 28, 2004

(51) Int. Cl. G03B 21/20

(52) U.S. Cl. 353/102

(57) ABSTRACT

An apparatus for enhancing output contrast of a projector is disclosed. In accordance to the spectrum of a light source, a thin-film coated light filter is mounted between the light source and a display unit to weaken the reflective light with a specific spectrum and achieve a white balance and enhance the contrast. The coating is to apply optical materials of low refractive index and high refractive index through vacuum deposition. For a light source of ultra-high-pressure mercury lamp, the light filter is coated with thin films on both sides where one with 19 layers and the other with 29 layers to obtain an optimum effect of green light weakening.

### BACKGROUND OF THE INVENTION

1. Field of the Invention

The invention generally relates to the field of projectors, and in particular relates to an apparatus applied in the optical engine of projector for contrast enhancement and filter coating wherein.

2. Description of the Related Art

Currently, image projectors are widely used in public and homes as a convenient display device for showing brief or films in a large size. Developments on projectors are to reduce the dimensions and weight, and to enhance the brightness, contrast and image quality. Especially for portable projectors, users appreciate the convenience and always-readiness. Further, as micro planar displays save a lot of weight and space, they can provide high quality large images as long as there are suitable optical engines incorporated.

The lamps used in projectors are usually ultra-high-pressure mercury (UHP) lamps. The spectrum of UHP lamp at green band is stronger than the red and blue bands, so that the whole spectrum is white but biased to green. In order to improve the white balance, it is usually adjusted by controlling the green light output according to V-T curve of micro display. By reducing the green light voltage to make the red, green and blue lights balanced, the required color temperature is obtained. This is the so-called “white balance”. However, common voltage adjustment has a range limitation; reducing the green light voltage also limits the grayscale adjustment range, so that the light efficiency is lower and some power is wasted.

Besides the aforesaid voltage adjustment, the white balance can also be achieved by improving the components of an optical engine. A retarder stack technology is being used. The retarder stacks utilize polarization for controlling color. The retarder stacks efficiently rotate the state of polarization of a primary color band by 90°, while the complementary color band retains the input state of polarization. As shown in FIG. 1, the green light has been weakened. The disadvantages of the technology are that the retarder stacks are difficult to be made and the costs are increased. Therefore, though the poor contrast of V-T curve of micro display can be improved, the cost of the whole projector is increased and the commercial application of the retarder stack is difficult.

In consideration of the aforesaid problems and the market's need, the inventor researches and develops a new contrast enhancement apparatus for projector, which uses a special optical coating element to reduce the green light spectrum and obtain a whiter output. The present coating technology can accord to the demands and make different wave band filters, like FIG. 2 shows, the illustrations 2a, 2b, and 2c respectively representing spectra of blue light filter (low pass), green light filter (band pass), and red light filter (long pass). The three kinds of light filters let red, green, and blue lights pass respectively and reflect the other wave bands of light. The principle is to use two different wave band filtering films and produce a wave band we need, for example, a green light filter in FIG. 2b is synthesized from that of FIG. 3a and FIG. 3b. Using the principle of such coated filters, as well as the reversed characteristics between a light penetration spectrum and its reflection spectrum, it is feasible to manufacture a filter that weakens the green light. The optical coating method compared to the voltage adjustment has a higher contrast and better grayscale effect for display. The manufacturing process is also simpler and the cost is lower when being compared to the retarder stacks.

### SUMMARY OF THE INVENTION

The object of the invention is to provide an apparatus capable of enhancing output contrast of a projector. It uses a two-side coated special light filter to reduce the green light intensity in a reflective light of a light source. In accompany with suitable optical engine design, it validly enhances the contrast and obtain a better grayscale effect.

In order to achieve the aforesaid object, in an embodiment of the invention, an apparatus for enhancing output contrast of a projector at least includes: a light source for providing a light energy; a first lens array for gathering and unifying the light energy; a first concentration lens, located on one side of the first lens array, for concentrating and increasing brightness of the light provided by the light source; a thin-film coated light filter, located in a line connecting the light source and the first lens array, has its surface inclined with an angle to the light coming from the light source; the surface of the light filter is coated with multilayer films correspondent to wave band of the light source for weakening a partial spectrum intensity of the reflective light and providing a balanced white light; a second concentration lens, located in the path of reflective light from the light filter, for gathering and unifying the reflective light; a display unit, located in the other side of the second lens arrays, for receiving the reflective light after being gathered and unified by the second lens array and providing image; and a projection lens assembly, located beside the display unit, for deflecting and enlarging the image provided by the display unit.

The light source applied in the invention can be an ultra-high-pressure mercury lamp. The light filter is coated on both sides with thin-film coatings to reduce the green light intensity in the reflective light spectrum. The surface of the light filter and the incident ray of light source are arranged with an angle between 0 to 90 degrees. The coating process is to apply two optical materials of high refractive index and low refractive index on the filter through vacuum deposition and achieve the required smooth profile. The thin-film coatings on both sides of the filter in a preferred embodiment of the invention are 19 and 29 layers respectively.

### BRIEF DESCRIPTION OF THE DRAWINGS

The invention will become more fully understood from the detailed description given herein below. However, this description is for purposes of illustration only, and thus is not limitative of the invention, wherein:

FIG. 1 is a penetration spectrum of a light filter with retarder stacks of prior arts;

FIG. 2a is a penetration spectrum of a blue light filter;

FIG. 2b is a penetration spectrum of a green light filter;

FIG. 2c is a penetration spectrum of a red light filter;

FIG. 3a is a first penetration spectrum required for making a green light filter;

FIG. 3b is a second penetration spectrum required for making a green light filter;

FIG. 4 is a constructional view of an apparatus of the invention for enhancing output contrast of a projector;

FIG. 5a is a first reflection spectrum of a thin-film coating applied on the filter of the invention;

FIG. 5b is a second reflection spectrum of a thin-film coating applied on the filter of the invention;

FIG. 5c is a synthesized reflection spectrum of two thin-film coatings applied on a light filter of invention; and

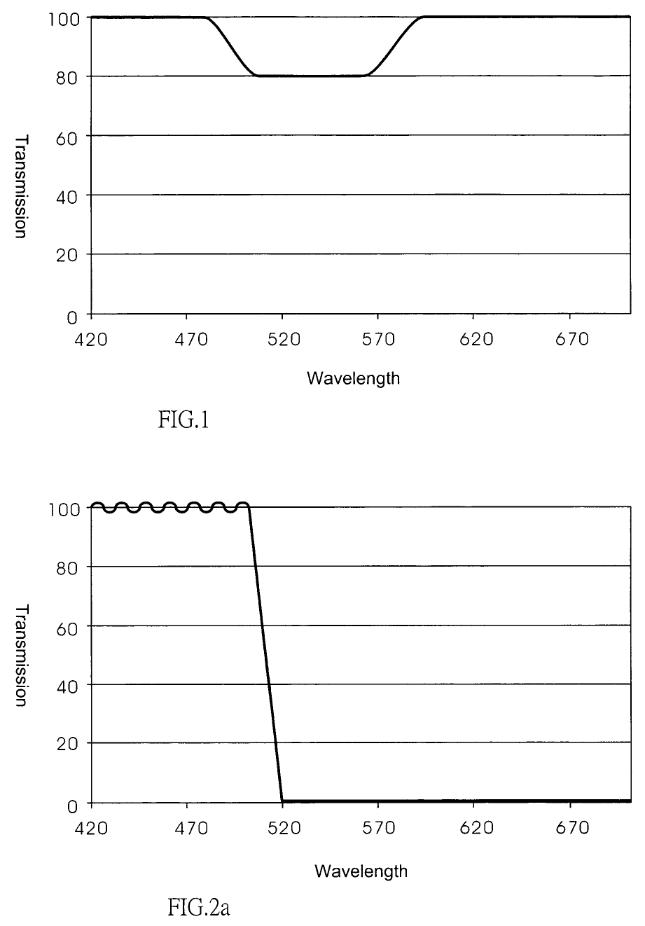

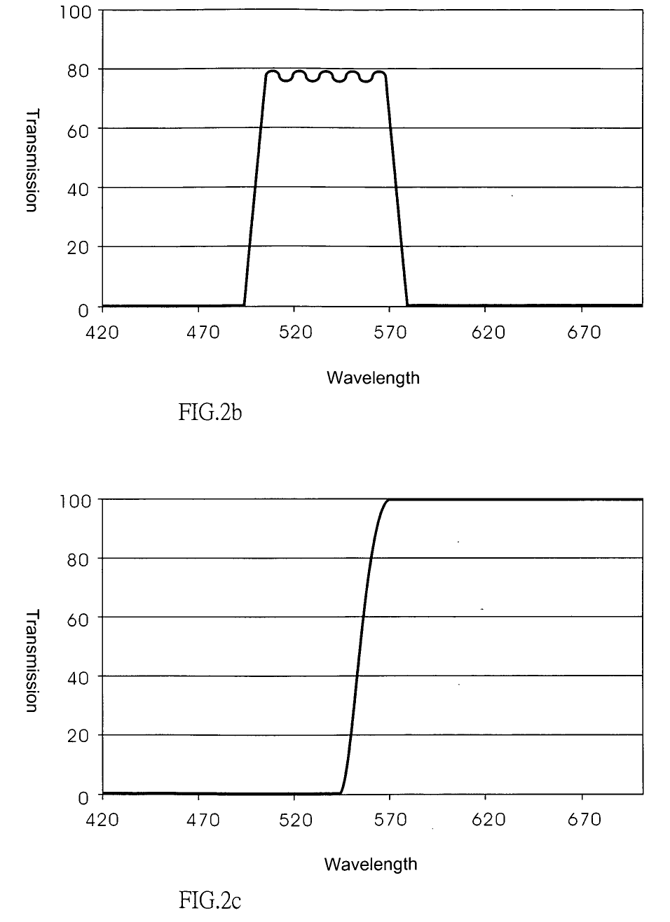

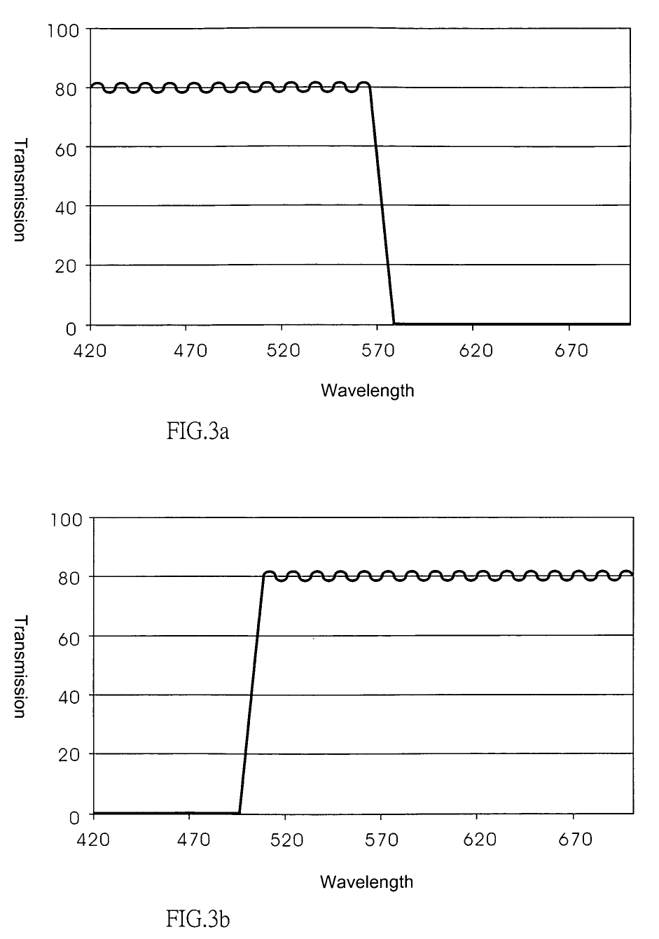

Table 1 is a comparison chart of output contrasts between voltage adjustment and optical coating methods.

### DETAILED DESCRIPTION OF THE INVENTION

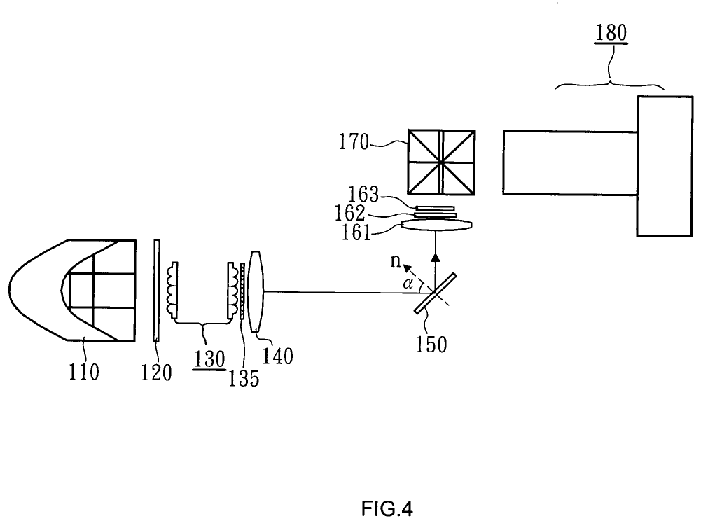

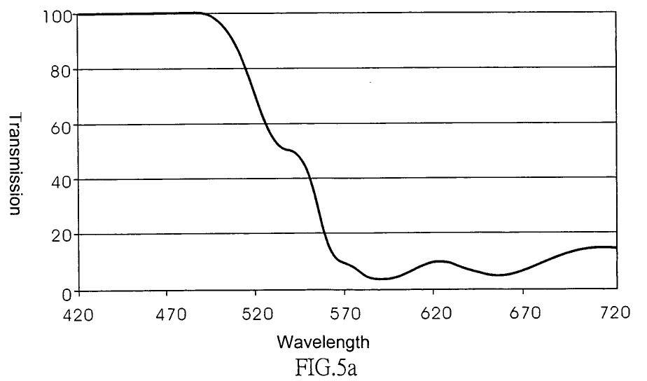

Please refer to FIG. 4, which is a constructional view of an apparatus of the invention for enhancing output contrast of a projector. This apparatus includes an ultra-high-pressure mercury lamp (UHP lamp) 110, an ultraviolet-infrared filter (UV-IR filter) 120, a lens array 130, a polarizer switch 135, a first concentration lens 140, a coated light filter 150, a second concentration lens 161, a polarizer 162, a retarder stack 163, a display unit 170 and a projection lens assembly 180. The UV-IR filter 120, the lens array 130, the polarizer switch 135 and the first concentration lens 140 are located on one side of the UHP lamp 110. The UV-IR filter 120 is located between the UHP lamp 110 and the lens array 130. The lens array 130 and the polarizer switch 135 are mounted between the UHP lamp 110 and the first concentration lens 140. The coated light filter 150 is located on the other side of the first concentration lens 140, and is located in a line connecting the UHP lamp 110 and the first concentration lens 140. The display unit 170 is located beside the coated light filter 150, but not in the line of the UHP lamp 110 and the first concentration lens 140. The display unit 170 includes reflective or penetrative light splitter and composer and a plurality of liquid crystal display panels. Between the coated light filter 150 and the display unit 170, there are the second concentration lens 161, the polarizer 162, and the retarder stacks 163. The projection lens assembly 180 is located in the output side the display unit 170.

The light provided by the UHP lamp 110 is removed of its ultraviolet and infrared rays by the ultraviolet-infrared filter 120, then focused, enhanced and unified by the lens array 130, the polarizer switch 135 and the first concentration lens 140, and projected with an incidence angle “alpha” to the surface of the coated light filter 150. The filter 150 weakens the green light intensity in the reflective light (which will be described in detail later). The reflective light goes to the display unit 170 via the second concentration lens 161, the polarizer 162, and the retarder stack 163 for enhancing the brightness and polarization. This reflective light is split and composed to illuminate the micro display in the display unit 170 where bright light is split into red, green, and blue lights, and composed again to form image. Finally, the image from the display unit 170 is deflected and enlarged by the projection lens assembly 180 to form an image projected on a screen (not shown in the drawing).

The incidence angle alpha of the light coming from the UHP lamp 110 to the normal direction of the coated light filter 150 is in a range of 0 to 90 degree, and preferably of 45 degree.

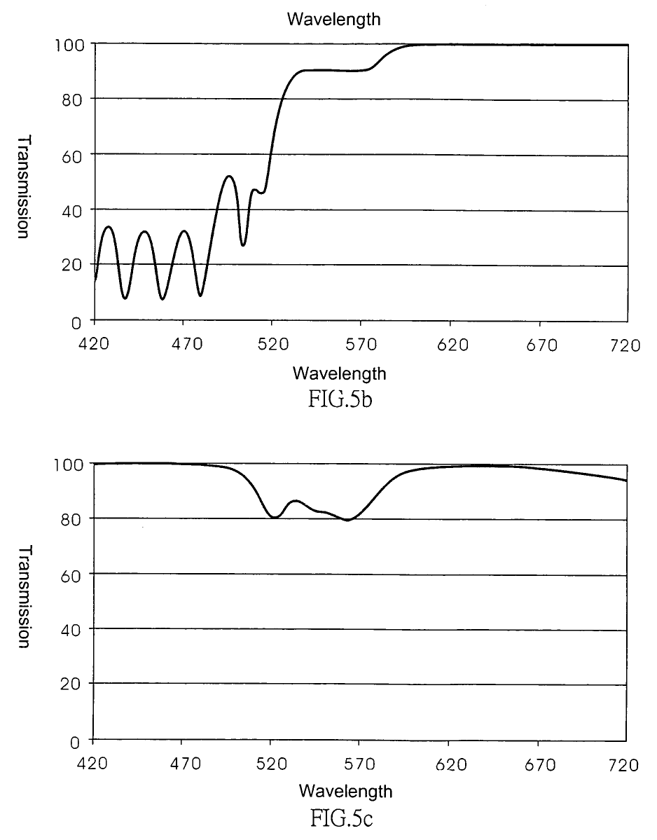

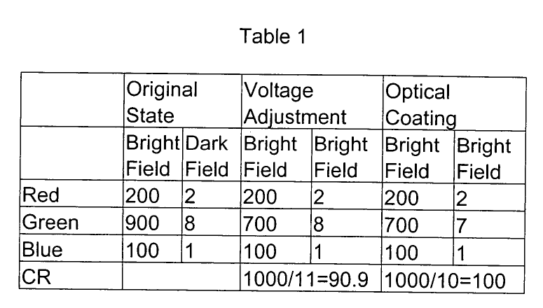

In order to weaken the green light intensity, the coated light filter 150 is made by vacuum deposition to form coatings on both sides of a B270 glass substrate. FIGS. 5a and 5b illustrate the reflection spectra of the coatings that make the reflective light conform with a reflection spectrum as shown in FIG. 5c when a light passes the two coatings of the coated light filter 150 to weaken the green light intensity. The coating process applies multiple layers of two optical materials including high refractive index titanium dioxide (TiO₂) and low refractive index silicon dioxide (SiO₂). The reason of selecting the two materials is that they minimally absorb the visible light spectrum and give a higher performance. Further, less layers of coating cannot provide a smooth spectrum and a sufficient reflection. However, more layers provide smoother reflective light, but the reflection is too high to meet the requirement. Therefore, preferred numbers of coatings on the light filter 150 surfaces are about 19 layers at one side and 29 layers at the other side, which give a 20% weakening of green light as an optimum result.

Table 1 shows a comparison of output contrasts between a voltage adjustment method and the optical coating method of the invention. As the table shows, a contrast ratio at original state is 1100:11. After being reduced with green light intensity in the bright field by voltage adjustment, the contrast ratio is 1000:11 because the voltage adjustment does not change the dark field intensity. However, the optical coating simultaneously changes the green light intensity in the bright field and the dark field, so that the contrast ratio is 1000:10. Therefore, in comparison with the voltage adjustment for weakening green light intensity, the optical coating of the invention can obtain a higher contrast and a better grayscale effect.

As described above, the invention provides a special thin-film coated light filter to accompany with suitable optical engine design. The light provided by the light source is filtered into a required spectrum and reflected to the display unit so as to enhance the output contrast. The manufacturing process is simpler; the cost is lower; and deemed to be a better way than prior arts.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for enhancing output contrast of a projector, comprising:
a light source for providing a light energy;
a first lens array, located on one side of said light source, for gathering and unifying said light provided by said light source;
a first concentration lens, located on one side of said first lens array and make said lens array located between said light source and said first lens array, for concentrating and enhancing said light from said light source;
a thin-film coated light filter, located in a line connecting said light source and said first lens array, having a surface inclined with an incidence angle to said light from said light source for reflecting said light form said light source; said filter is coated with multilayer thin films for weakening said reflective light a partial spectrum intensity and providing a uniform white light;
a second lens array, located in a path of said reflective light from said light filter, for gathering and unifying said reflective light;
a display unit, located in another side of said second lens array, for receiving said reflective light from said second lens array and providing image; and
a projection lens assembly, located beside said display unit, for deflecting and enlarging said image provided by said display unit.

2. An apparatus for enhancing output contrast of a projector according to claim 1 wherein said light source is an ultra-high-pressure mercury lamp.

3. An apparatus for enhancing output contrast of a projector according to claim 2 wherein said thin-film coated light filter weakens green spectrum of said reflective light.

4. An apparatus for enhancing output contrast of a projector according to claim 1 further comprises an ultraviolet-infrared filter located between said light source and said first lens array.

5. An apparatus for enhancing output contrast of a projector according to claim 1 further comprises a polarizer switch located between said first lens array and said first concentration lens.

6. An apparatus for enhancing output contrast of a projector according to claim 1 wherein said incidence angle of said light from said light source to surface of said thin-film coated light filter is between 0 to 90 degrees.

7. An apparatus for enhancing output contrast of a projector according to claim 1 wherein said thin-film coated light filter is made by vacuum deposition.

8. An apparatus for enhancing output contrast of a projector according to claim 1 wherein said thin-film coated light filter comprises multiple layers of two optical materials of high refractive index and low refractive index.

9. An apparatus for enhancing output contrast of a projector according to claim 7 wherein said high refractive index material is titanium dioxide.

10. An apparatus for enhancing output contrast of a projector according to claim 7 wherein said low refractive index material is silicon dioxide.

11. An apparatus for enhancing output contrast of a projector according to claim 1 wherein said thin films are coated on both sides of said light filter.

12. An apparatus for enhancing output contrast of a projector according to claim 11 wherein said thin-film coated light filter is coated with 19 layers on one side, and 29 layers on the other side.

13. An apparatus for enhancing output contrast of a projector according to claim 1 further comprises a polarizer located between said second concentration lens and said display unit.

14. An apparatus for enhancing output contrast of a projector according to claim 1 further comprises a retarder stack located between said second concentration lens and said display unit.

15. An apparatus for enhancing output contrast of a projector according to claim 1 wherein said display unit comprises light splitter and composer and at least a liquid crystal display panel.

16. An apparatus for enhancing output contrast of a projector according to claim 14 wherein said light splitter and composer is a reflective composition.
